(19) United States
(12) Patent Application Publication
(10) Pub. No.: US 2007/0058386 A1
(43) Pub. Date: Mar. 15, 2007

(54) METHOD OF CONSTRUCTING A HEADLIGHT MODULE FOR A MOTOR VEHICLE, AND THE MODULE AND HEADLIGHT

(75) Inventor: Pierre Albou, Paris (FR)

Correspondence Address: MATTHEW R. JENKINS, ESQ., 2310 FAR HILLS BUILDING, DAYTON, OH, 45419, US

(73) Assignee: VALEO VISION, Bobigny Cedex (FR)

(21) Appl. No.: 11/530,133

(22) Filed: Sep. 8, 2006

(30) Foreign Application Priority Data
Sep. 9, 2005 (FR) 0509234
Mar. 17, 2006 (FR) 0602391

(51) Int. Cl. F21V 5/00

(52) U.S. Cl. 362/520; 362/521; 362/522

(57) ABSTRACT

The invention concerns a method of constructing a headlight module giving a beam with cutoff, for a motor vehicle, comprising a lens and a light source disposed at the rear of the lens, from which it is separated by air, the light source being formed by at least one light emitting diode, according to which the exit surface of the lens is chosen so that it can possibly be connected on a smooth continuous surface with the exit surfaces of similar adjacent modules, and the entry surface of the lens is determined so as to obtain the cutoff of the light beam without using an occulting shield.

### BACKGROUND OF THE INVENTION

1. Field of the Invention

The invention relates to a method of constructing a headlight module giving at least one beam with cutoff, for a motor vehicle, of the type that comprises a lens and a light source disposed behind the lens, from which it is separated by air, the light source comprising at least one light emitting diode.

2. Description of the Related Art

Light emitting diodes, referred to hereinafter in abbreviation as “LED” or “diode”, deliver relatively limited light fluxes, around 100 lumens. Thus, in order to fulfill lighting functions for a motor vehicle and to obtain the necessary light flux, it is necessary to use several diodes: for example, for a headlight of the dipped type, around ten diodes or more are frequently provided, and as many modules to a single diode. The result is a pixelised or dotted appearance of the headlight, which is not desired. The external surface of the headlight may have discontinuities in the junction zones of the juxtaposed modules, which is also not desired. The radii of curvature of this external surface are generally not adapted to those of the adjoining bodywork parts, which does not suite styling. The fusion of the light beams of the various modules also requires to be improved.

### SUMMARY OF THE INVENTION

The aim of the invention is in particular to create a headlight module with a lens that can be assembled continuously in switched-off appearance with adjacent modules, and making it possible to create controlled light beams, without any constraint of radius of curvature on the exit surface of the overall part forming the headlight. The module with lens must preferably be able to provide complex beam cutoff shapes.

Another aim is to obtain a module with an LED and lens that is adaptable with a view to providing various types of beam, in particular beams or portions of a beam with a flat or oblique cutoff, such as dipped beams or so-called motorway beams.

According to a first embodiment of the invention, the method of constructing a headlight module for a motor vehicle, of the type defined above, is such that the exit surface of the lens is chosen so that it can be connected along a smooth continuous surface with the exit surfaces of similar adjoining modules, and that the entry surface of the lens is determined so as to obtain the cutoff of the light beam without using an occulting shield.

In the context of the invention,“occulting shield” means a cover that intercepts the light reaching it essentially by absorption (as opposed to an element reflecting the light in particular).

In the context of the invention, “similar modules” means modules whose external appearance is similar and also that comprise a lens in at least one light emitting diode, but that can generate either a beam with cutoff or a beam without cutoff (of the main beam type).

These similar modules can also be modules as defined above but equipped with at least one light emitting diode emitting essentially in the infrared and not in the visible range, and this in particular to make it possible to emit an infrared distribution beam without cutoff of the main beam type for assistance in driving at night.

According to a second embodiment of the invention, which can be added to the previous one, the object of the invention is a method of constructing headlight module giving a beam with cutoff, for a motor vehicle, comprising a lens and a light source disposed at the rear of the lens from which it is separated by air, the light source being formed by at least one light emitting diode. The method is such that the exit surface of the lens is chosen and the entry surface of the lens is determined by relying on a horizontal generatrix, so as to obtain the cutoff of the light beam emitted by the module without using an occulting shield, and with a controlled horizontal distribution of the light beam.

Throughout the remainder of the text, the terms bottom, top, horizontal and vertical will be understood as referring to the positioning of the module or headlight in the position of mounting in the vehicle.

The exit surface of the lens is preferably chosen as being substantially cylindrical or toric, the section of the exit surface of the lens through a vertical plane parallel to the optical axis being convex towards the front.

The curvature or curvatures of the exit surface of the lens can be chosen so as to be substantially equal to the curvature or curvatures of the walls surrounding the module.

For constructing a module comprising an ellipsoidal reflector and a bender, the exit surface is advantageously chosen as being that of a cylinder of revolution whose section through a vertical plane passing through the optical axis is an arc of a circle convex towards the front, and the entry surface is constructed so as to be stigmatic between the second focus of the ellipsoidal reflector and infinity.

For constructing a module with diode in direct view of the lens, the exit surface is generally chosen to be toric, with a vertical axis of revolution, and the entry surface is constructed so as to create a horizontal cutoff.

The invention also relates, according to a first embodiment of the module, to a headlight module for a motor vehicle comprising a lens and, at the rear of the lens, a light source separated from the lens by air and formed by at least one light emitting diode, this module being such that the exit surface of the lens is entirely convex towards the front and is such that it can be connected along a smooth continuous surface with the exit surfaces of the lenses of similar adjacent modules, and the entry surface of the lens is defined so that the module gives a light beam with cutoff without the intervention of an occulting shield, in particular vertical.

It also relates, according to a second embodiment of the module (which can possible be added to the first) to a headlight module giving a beam with cutoff, for a motor vehicle, comprising a lens and a light source disposed at the rear of the lens, from which it is separated by air, the light source comprising at least one light emitting diode, such that the exit surface of the lens is entirely convex towards the front, and the entry surface (Ae1 -Ae5) of the lens is defined by relying on a horizontal generatrix, so that the module gives a light beam with cutoff without the intervention of an occulting shield, in particular vertical, and with a horizontal distribution.

According to a variant of this second embodiment, the entry surface (Ae6) of the lens is calculated so that a family of light rays, referred to as limit rays, issuing from the emitter of the light source, emerge from the lens so that they are all normal, at the points where they encounter it, to a cylindrical surface, referred to as the exit wave surface, with vertical generatrices and any cross-section (the choice of a cross-section or more generally of a directrix of the exit wave surface makes it possible to control the horizontal distribution of the energy in the beam and here replaces the choice of the “generating curve” of the previous variant). The limit rays are chosen so that all the other light rays issuing from the source reach the entry face of the lens at the same point as they emerge from the exit face (As6) with a negative or zero vertical component directing vector. In this way, the beam generated has a horizontal cutoff line and all the images of the emitter encountered at this limit line at infinity are at one point. In this second variant (subsequently referred to as IIβ), the entry surface of the lens is in general discontinuous, the points (referred to as foci) of the emitter from which the limit rays issue being different depending on whether the point of emergence of the limit ray at the surface of the source reaches the entry face of the lens at a point situated above or below (along the vertical axis Z) thereof. It goes without saying that the physical part comprises a continuous surface consisting of the top and bottom surfaces mentioned above and a connecting surface, ideally adjusted, with generatrices parallel to the optical axis and, in practice, to the generatrices inclined with respect to this axis so as to enable the lens to be removed from the mould.

The advantage of the variant IIβ lies in the possibility of calculating the exit surface (in two parts) directly (one equation for each point, independent of the adjoining points) rather than from place to place, which causes the propagation of calculation errors and possibly numerical oscillations. In addition, the choice of the exit wave surface imposes precisely the direction of the most steeply rising radius of each image according to its point of emergence at the exit surface of the lens, whilst the “generating curve” of the previous variant constitutes only one of the conditions at the limits for a system of partial derivative equations and, though it makes it possible in fact to control the horizontal distribution of the energy, cannot be directly connected to the horizontal position of an image issuing from a given point on the exit surface.

The exit surface of the lens may be cylindrical or toric, the cross-section of the exit surface of the lens through a vertical plane parallel to the optical axis being convex towards the front.

The curvature or curvatures of the exit surface of the lens may be substantially equal to the curvature or curvatures of the walls surrounding the module on the vehicle.

The headlight module may comprise an ellipsoidal reflector and a bender, in which case the exit surface is advantageously chosen as being that of a cylinder of revolution whose cross-section through a vertical plane passing through the optical axis is an arc of a circle convex towards the front, and the entry surface is constructed so as to be stigmatic between the second focus of the ellipsoidal reflector and infinity.

The form of the edge of the bender can be designed so that the light beam has a V-shaped cutoff.

The edge of the bender can have a deformation in a valley in order to partly compensate for the aberrations of the lens.

The edge of the bender can have, on each side of the vertical plane passing through the optical axis, two protrusions connected by a bowl-shaped part in order to constitute an additional module for a motorway dipped beam, reinforcing the light in the axis below the horizontal.

Advantageously, the entry surface is such that the optical path is constant from the external focus of the reflector as far as a plane tangent to the exit face at its point of intersection with the optical axis of the module.

According to another possibility, the focus of the lens is offset transversely with respect to the optical axis and the module illuminates in a lateral direction with respect to the optical axis, the entry surface of the lens being such that the optical path is constant between the focus of the lens and a vertical plane whose trace on the horizontal plane of the optical axis is inclined with respect to this axis.

In the case of a module whose light source is in direct view of the lens, the exit surface of the lens is chosen so as to be toric with a vertical axis of revolution, and the entry surface is defined so as to give a light beam with horizontal cutoff. The light source can consist of a rectangular lambertian emitter placed in a vertical plane, orthogonal to the optical axis, or by a light emitting diode comprising a transparent protective dome situated above the emitter, itself placed in the air.

According to a variant of the invention, the module comprises a light emitting diode in direct view of the lens, the diode being disposed on a plane oblique with respect of the optical axis of the module. In this case, a light emitting diode comprising a transparent protective dome situated above the emitter is preferably chosen. Thus inclining the diode modifies the form and distribution of the beam complementary to the dipped beam emitted by the module: when it is wished to obtain a so-called motorway beam that is in accordance with the regulations, a beam portion is required which is of high intensity and thin.

With a diode disposed so as to emit perpendicular to the lens, there is a tendency in fact to obtain a beam roughly rectangular in shape but generally fairly “thick” and not very intense. To make the beam less “thick”, it would be possible to increase the focal length of the lens, but it is then necessary to increase the diode/lens distance, and therefore to increase the dimensions of the module, which is not always possible and complicates the integration of the module in the headlight.

Another very effective solution for controlling/reducing the thickness of the beam has therefore consisted of inclining the diode with respect to the lens: they thus are no longer situated entirely opposite each other. It should be noted that this inclination can be chosen at a positive or negative angle with respect to the optical axis, the two types of inclination making it possible to adjust the thickness of the beam in a comparable fashion.

Advantageously, the diode is sufficiently inclined so that the angle at which the emitter of the diode is seen from a majority of points (corresponding to at least 75% of the entry surface for example) on the lens is smaller than it would be with a lens disposed on a plane perpendicular to the optical axis of the module.

Another favorable condition consists of choosing the inclination of the diode so that the ray most inclined with respect to the axis of the emitter of the diode reaching the lens is smaller than the limit angle of the distribution of the light beam emitted by the diode. This makes it possible to prevent an area of the lens no longer receiving any light from the emitter.

An appropriate inclination is for example an angular difference with respect to the optical axis of the module of around +/−35° to +/−50°, in particular +/−40° to +/−50°, for example +45° or −45°.

As mentioned above, by inclining the diode, it is possible easily to obtain with the module a beam or a beam portion of the motorway type, having in particular a beam thickness of less than 5% (which corresponds to 2.852°), in particular less than 3% (which corresponds to 1.718°), a high intensity, in particular at least 40 lux at 25 meters, and a cutoff above the horizontal part of the cutoff of the dipped beam. This cutoff is sharp and is naturally situated below the dazzle limit defined in the regulations concerned.

According to another variant, the module can comprise a light source including a light emitting diode in direct view of the lens, the module being such that, in the mounting position, the emitter of the diode and the lens are both inclined laterally in a vertical plane, in particular in order to obtain a beam or a light beam portion with oblique cutoff.

It will therefore be understood that the present invention proposes modules with light emitting diodes that are in direct view of associated lenses, and in this case there is neither reflector nor “bender”, and modules with light emitting diodes that are associated with reflector and bender, in addition to the lens.

The invention also relates to a headlight giving a beam with cutoff, for a motor vehicle, such as is formed by an assembly of several modules as defined above, juxtaposed so that the exit surface of the lens of the headlight is smooth and continuous.

The headlight advantageously consists of several superimposed rows of assembled modules, some of the modules providing a cutoff at 15°, other modules being able to illuminate laterally, each switched-off row having the external appearance of a single cylindrical ray or a continuous toric segment.

The invention also concerns any assembly of modules that assembles a plurality of modules at least some of which provide an oblique cutoff as described above, with other similar modules able to emit a beam without cutoff and possibly with similar modules able to illuminate laterally. It is thus possible to insert in a headlight one or more rows associating dedicated dipped beam modules with dedicated main beam modules in the visible range and/or main beam modules in the infrared range, keeping a unity of external appearance that is very advantageous for the style of the headlight overall.

The invention also concerns any unitary module for making a beam or a portion of a beam with horizontal or oblique cutoff. If it is intended to emit a portion of a beam, it is possible to supplement it with another complementary beam, emitted by a different module already known, using for example conventional light sources of the halogen or xenon type.

The invention consists, apart from the provisions disclosed above, of a certain number of other provisions that will be dealt with more explicitly below with regard to example embodiments described with reference to the accompanying drawings, but which are in no way limiting.

### BRIEF DESCRIPTION OF THE DRAWINGS

FIG. 1 is a schematic view in vertical section of a first embodiment of a module with ellipsoidal reflector according to the invention;

FIG. 2 is a schematic view in horizontal section along the line II-II in FIG. 1;

FIG. 3 is a schematic left hand view with respect to FIG. 1 of the ellipsoidal reflector of the module and bender;

FIG. 4 is a diagram illustrating, in vertical section, the construction of the entry surface of the lens of the module in FIG. 1;

FIG. 5 is a representation of the isolux curves of the light beam obtained with the module of FIG. 1;

FIG. 6 is a schematic front view, similar to FIG. 3, of the ellipsoidal reflector and bender of a module giving a beam of the “motorway lighting” type (dipped beam for motorway);

FIG. 7 is a representation of the network of isolux curves of the beam obtained with the module in FIG. 6;

FIG. 8 is a diagram in plan view illustrating a construction of a module illuminating in a lateral direction;

FIG. 9 is a schematic view in horizontal section of a module according to FIG. 8;

FIG. 10 depicts the network of isolux curves obtained with the module in FIG. 9;

FIG. 11 is a diagram in perspective illustrating the method of constructing a second embodiment of the module according to the invention in which the light source directly illuminates the entry face of the lens;

FIG. 12 is a schematic vertical section of a first example of a lens constructed according to FIG. 11;

FIG. 13 depicts the network of isolux curves of a module including the lens in FIG. 12;

FIG. 14 is a schematic vertical section of another example of a lens constructed according to FIG. 11;

FIG. 15 depicts the network of isolux curves obtained with a module equipped with the lens in FIG. 14;

FIG. 16 is a schematic section through a vertical plane of a light emitting diode whose emitter is protected by a dome;

FIG. 17 is a schematic section through a horizontal plane of the diode of FIG. 16;

FIG. 18 is a schematic vertical section of a module according to the second embodiment with a diode directly illuminating the entry face of a lens;

FIG. 19 depicts the network of isolux curves obtained with the module of FIG. 18;

FIG. 20 is a horizontal schematic section of an assembly of several modules according to the invention;

FIG. 21 is a schematic front view of a headlight with superimposed assemblies of modules;

FIG. 22A and 22B are schematic views in perspective of two adjacent modules according to the invention, FIG. 22A with diodes disposed perpendicular to the optical axis of the modules, FIG. 22B with diodes inclined with respect to the optical axis of the modules;

FIGS. 23A and 23B are networks of isolux curves obtained with the modules according to FIGS. 22A and 22B;

FIGS. 24A and 24B concern a variant embodiment, with a view of the diode and of the lens and the corresponding isolux curves with a view to obtaining a beam of the fog type;

FIGS. 25A and 25B concern a variant embodiment with a view of the diode and of the lens and the corresponding isolux curves with a view to obtaining a beam of the motorway type; and

FIG. 26 concerns a representation of a diode illustrating a method of constructing a surface explained below.

### DETAILED DESCRIPTION OF THE PREFERRED EMBODIMENTS

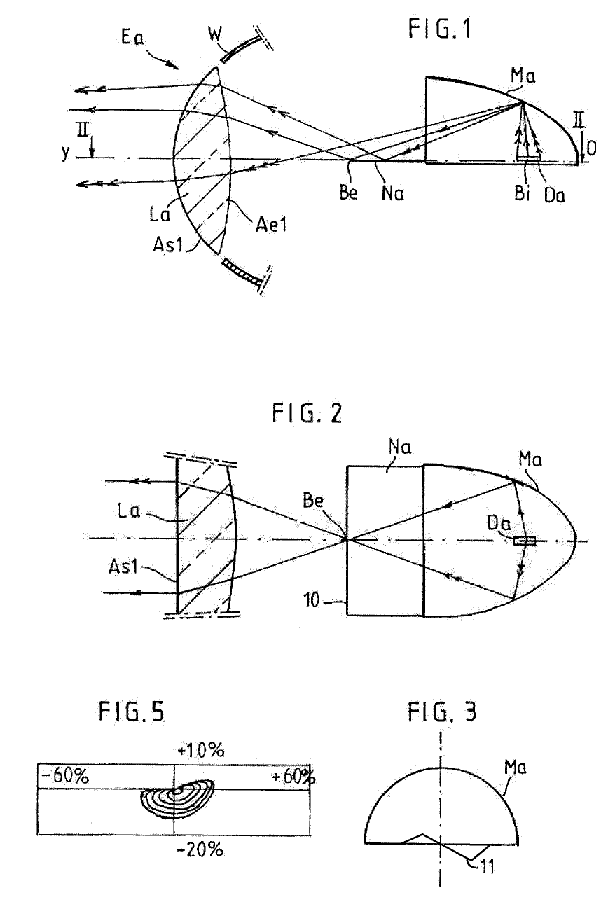

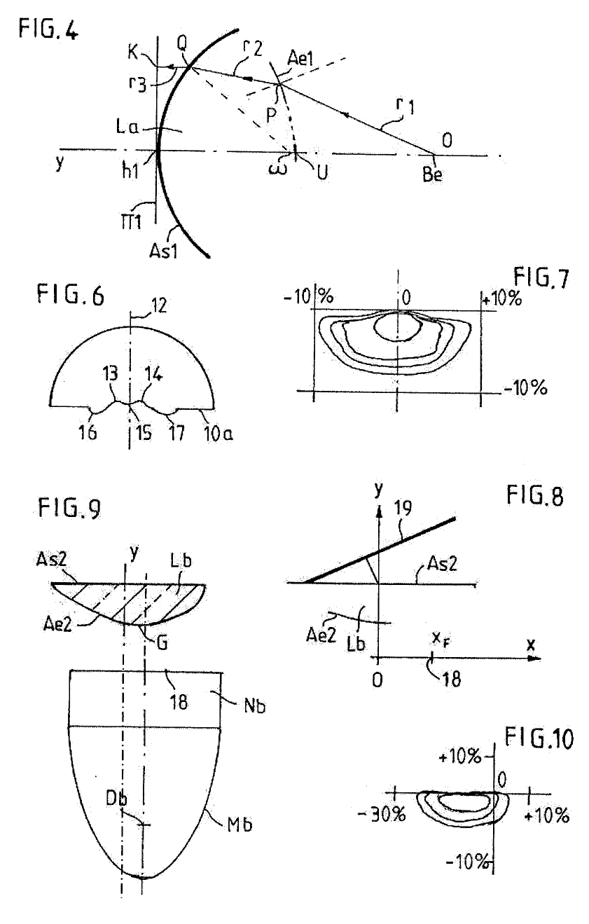

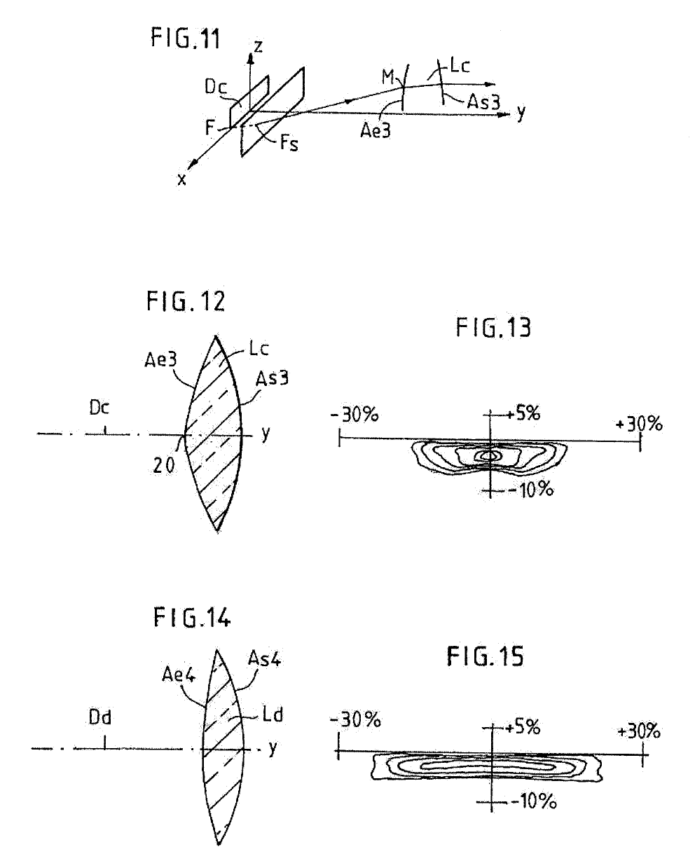

Referring to the drawings, in particular to FIGS. 1 and 2, FIG. 9, FIGS. 12 and 14, FIG. 18, it is possible to see, depicted schematically, a headlight module for a motor vehicle comprising a lens La, Lb, Lc, Ld, Le and a light source formed by at least one light emitting diode Da, Db, Dc, Dd, De disposed at the rear of the lens. An air space separates the diode from the lens.

In the description and claims, the terms “front” and “rear” are to be considered in the direction of propagation of the light flux from the source towards the lens, and the module is to be considered in the position that it occupies on the vehicle, that is to say with its optical axis horizontal.

According to the invention, in order to construct the headlight module, the following procedure is adopted.

The exit surface As1, As2, As3, As4, As5 of the lens La, Lb, Lc, Ld, Le is chosen so that it can be connected on a smooth continuous surface with the exit surfaces of similar adjoining modules. This exit surface is also chosen so as to have a curvature preferably substantially equal to that of the walls W (FIG. 1) that surround it, in particular the walls of the body of the vehicle. The exit surface is entirely convex towards the front.

The entry surface Ae1, Ae2, Ae3, Ae4, Ae5 of the lens is determined so as to obtain, without a vertical cover, a light beam with cutoff with a spreading of the light.

The exit surface As1-As5 of the lens is preferably chosen as being:
a. a portion of a cylindrical surface of revolution whose generatrices are horizontal, orthogonal to the optical axis of the module,
b. or a portion of a toric surface with a vertical axis of revolution.

The case of the cylindrical surface can be considered as the particular case of a toric surface whose axis of revolution is to infinity.

The exit surface of the lens admits a horizontal symmetry plane passing through the optical axis of the module; the cross-section of the exit surface, cylindrical or toric, through a vertical plane passing the optical axis is an arc of a circle convex towards the front.

The radii of curvature in a horizontal plane and in a vertical plane of the exit surface of the lens are freely chosen so as to match the curvatures of the walls W surrounding the module.

Two methods of constructing the module are provided.

According to a first method, corresponding to FIGS. 1 to 10, the module comprises an ellipsoidal reflector Ma, Mb having two foci, namely an internal focus in the vicinity of which the light source is placed and an external focus merged with the focus of the lens or adjacent to this focus. The light source does not directly illuminate the entry face of the lens but illuminates toward the reflector, substantially at a right angle with respect to the optical axis of the module. A bender Na, Nb is situated in the horizontal plane passing through, or adjacent to, the optical axis of the module. The front edge of the bender passes through the focus of the lens.

According to another embodiment, corresponding to FIGS. 11 to 19, the light source is in direct view of the entry face of the lens, without the intervention of a reflector or a bender.

These embodiments will be described successively.

I. Module With Ellipsoidal Reflector And Bender.

Referring to FIGS. 1 and 2, a headlight Ea can be seen, comprising a light source consisting of at least one LED Da whose maximum point of emission is preferably situated at the internal focus Bi of the ellipsoidal reflector Ma. The external focus Be is situated in the front of Bi. The reflector Ma corresponds substantially to the rear top quarter of an ellipsoid of revolution whose geometric axis is merged with the optical axis Oy of the module and of the lens La, situated in front of the external focus Be.

To locate the points in space, a reference trirectangular trihedron is used whose axis Oy corresponds to the optical axis of the module, whose axis Ox is orthogonal to Oy in the horizontal plane and whose axis Oz is vertical.

The diode Da is oriented so as to illuminate essentially upwards, substantially at right angles with respect to the optical axis Oy, in the direction of the reflector Ma. The rays issuing from Bi are reflected in order to converge towards the focus Be merged with the focus of the lens La.

The module also comprises a bender Na, that is to say a plate whose top surface is reflective, situated in a horizontal plane passing through the optical axis Oy and whose front edge 10 passes through the focus Be, and determines the cutoff line of the light beam. The illumination is situated below the image of this edge given by the lines La.

The exit surface As1 is chosen so that it can be connected along a smooth continuous surface with exit surfaces of similar adjacent modules, whilst having a curvature adapted to the surrounding walls W.

The entry surface Ael of the lens is determined so as to obtain a light beam with cutoff with spreading of the light. The surface Ael is constructed so as to be stigmatic between the second focus Be of the reflector Ma and infinity.

In other words, as illustrated in FIG. 4, Ae1 is such that a light ray r1 coming from the focus Be and propagating in the air, after entry into the lens La and refraction along r2, leaves the surface As1 along a ray r3 parallel to the optical axis Oy. The optical path is constant between the focus Be and a plane ø1 tangent to the exit face As1 at its point of intersection h1 with the optical axis of the module.

In the case of FIGS. 1, 2 and 4, the exit surface As1 is chosen as being that of a cylinder of revolution with a horizontal geometric axis, orthogonal to the optical axis. (It could also have a substantially toric shape.) The cross-section of the surface As1 through the vertical plane in FIG. 4 is an arc of a circle having its centre at the point ω situated on the optical axis Oy, in front of the external focus Be, the generatrices being perpendicular to the plane of FIG. 4. The construction in three dimensions then takes place in all the vertical planes and parallel to the optical axis Oyz.

P designates the running point of the entry surface Ae1, Q designates the exit point of the radius r2, U designates the entry point of the ray along the optical axis, and K designates the intersection with the plane ø1 of the parallel to the optical axis passing through the point Q. With n designating the refractive index of the material of the lens, the constancy of the optical path from the external focus Be as far as the plane ø1 is expressed by:
BeP+(n.PQ)+QK=constant=BeU+(n.Uh1)

In the construction in three dimensions, along the other planes, ω, P, Q, r2 and r3 remain identical to those depicted in FIG. 4. On the other hand, O and r1 are then points in space that no longer belong to the cutting plane according to FIG. 4.

By juxtaposing modules in the direction of the generatrices of the exit surface As1 a bar is obtained whose external surface is cylindrical, smooth and continuous.

Several LEDs can be disposed in parallel to the generatrices of the exit surface. The successive front edges 10 of the benders of the various modules are aligned parallel to the generatrices of the cylindrical surface As1.

It is possible to reflect a cutoff in a V in particular with a horizontal branch to the left and a branch rising at an angle of 15° to the right (European dipped beam), providing an appropriate edge for the bender. The cutoff lines of the various modules are aligned, which is found again with regard to the image on a screen. FIG. 5 gives the diagram of the isolux curves obtained with a module as defined previously.

A lens with a cylindrical exit surface As1 has aberrations that can be compensated for partly by a modification of the shape of the edge of the bender 10 by providing a deformation 11 (FIG. 3) in the form of a protrusion, preferably in a vertical plane. FIG. 3 illustrates a form of bender with a branch rising substantially rectilinear towards the right, and a branch with a break in slope on the left.

By changing the form of the bender and of its edge passing through the focus Be, whilst taking account of the aberrations, it is possible to create other types of light beam.

For example, according to FIG. 6, the edge 10a of the bender has, on each side of the vertical plane 12 passing through the optical axis, two protrusions 13, 14 connected by a part 15 in a bowl shape. The protrusions 13, 14 are extended on each side by recessed zones 16, 17 that rise in order to join the edge situated in the horizontal plane passing through the optical axis.

Such a module can constitute an additional module or a motorway dipped beam (motorway lighting) that makes it possible to reinforce the light in the axis, below the horizontal.

FIG. 7 illustrates the isolux network obtained with the module of FIG. 6, which has a maximum intensity in the axis, the isolux curves being situated below the horizontal intersecting the optical axis, whilst being substantially symmetrical with respect to the vertical plane passing through the optical axis.

For composing a complete light beam obtained from the light beams produced by each of the modules of a headlight, advantageously one or more modules are provided having an exit face identical to that of the modules giving a cutoff at “15°” (FIG. 5), but illuminating in a lateral direction in order to supplement the beam with light under the cutoff, for example to the left for vehicles in countries driving on the right.

To this end, a module having a stigmatic lens Lb between a focus point 18 of abscissa x_{F} and a vertical planar wave inclined with respect to the optical axis and whose trace 19 on the horizontal plane is depicted, is constructed according to FIG. 8. The inclination of the planar wave is designed so as to promote lighting under the cutoff, to the left. The focus 18 of the lens Lb is offset to the right with respect to the straight line Oy passing through the centre of the exit face As2. The exit surface As2 of the lens is chosen so as to be cylindrical of revolution; its horizontal section on FIGS. 8 and 9 is a rectilinear generatrix. The entry surface Ae2 of the lens is constructed so that the optical path between the focus 18 and the trace vertical plane 19 is constant.

The lens Lb, a horizontal section of which is visible in FIG. 9, is asymmetric at its entry surface Ae2. As from a point G, corresponding to a maximum thickness, situated to the right of the optical axis Oy of the reflector Mb, the lens Lb decreases in thickness towards the left less rapidly than towards the right.

The isolux network obtained with a headlight according to the diagram in FIG. 9 is illustrated in FIG. 10. The isolux curves are situated below the horizontal passing through the optical axis, and essentially to the left of the vertical plane passing through the optical axis.

This result is obtained with a module whose exit face is similar to that of the modules giving a cutoff at 15°. The exit faces of the various modules can thus be connected continuously in order to give a smooth global surface seen from the front.

II. Module With Diode In Direct View Of The Lens

II.a Rectangular Emitter In A Vertical Plane

For constructing the module, the light source Dc (FIG. 11) is considered to consist of a rectangular lambertian emitter placed in a vertical plane, orthogonal to the optical axis, behind a known primary lens, imposed by the manufacturer of the light emitting diode.

The exit surface As3 (FIG. 12) or As4 (FIG. 14) of the lens is chosen and the entry surface Ae3 or Ae4 is constructed so as to create a horizontal cutoff for given deviations in plan view. In practice toric surfaces with a vertical axis of revolution are chosen for the exit surfaces As3 or As4, whilst the primary lens of the light source Dc consists of a single plane, which corresponds to the case of a lambertian emitter immersed in a resin, behind a planar exit face.

As illustrated in FIG. 11, in order to construct the entry face Ae3, an unknown point M is considered, of coordinates x, y, z of the surface sought. It is assumed that x and z are known and y unknown (meshing in Cartesian coordinates, in rear view).

For a planar rectangular light source Dc situated in the air and without a primary lens, the entry surface is constructed at point M so that the rays issuing from the source Dc and passing through M are descending, or at most horizontal, at the exit from the lens Lc. For this, a limit ray coming from the source Dc and which, arriving at point M, has the greatest rising inclination is taken into account. The entry surface element at M is constructed so that the ray leaving the lens, issuing from this limit ray, is straightened up horizontally. Under these conditions, all the other rays issuing from the source Dc, which arrive at M with a less great rising inclination, will be descending on leaving the lens.

The point F of the emitter on FIG. 11 situated as the lowest and closest to the plane parallel to the plane (Oyz) passing through M, if M is situated in the zone where M is greater than 0, and furthest away from this plane if M is situated in the zone where M is less than 0, is the one that will give the most inclined rising ray reaching M, that is to say the limit ray. (In the case where M is situated in the zone where z is negative it is possible, in order to simplify the construction, to use an approximate construction consisting of choosing the point symmetrical with respect to (Oyz) to the point closest to the plane cited.) In the case where an exit lens acts on the light source, which in practice corresponds to all cases, it is necessary to take into account and consider the exit point Fs on this lens whilst on the emitter. In the case where the exit lens consists of a single plane, at a short distance from the emitter, the choice of the point F indicated previously remains acceptable. The exit point Fs on the exit plane is determined so as to derive therefrom the direction of the limit ray at M. The final condition is established for a given point M on the entry surface (horizontality of the limit ray at M when it emerges from the toric exit surface) analytically according to a single unknown (y), of design parameters and two very close points already known M1 and M2.

The search for a point adjacent to two known points can be made effectively and precisely: it amounts to the resolution of a non-linear equation with a single unknown.

The construction is based on two conditions at the limits defined by the sections of the surface to be constructed through the plane z=0 and x=0. The first section of the surface through the plane z=0 is arbitrary and constitutes the control parameter for the horizontal distribution of the light. Advantageously, it is possible to link the horizontal deviation of the light rays issuing from the origin of the reference frame contained in the plane z=0 to the abscissa of their intersection with the entry surface of the lens. A first case is illustrated by FIG. 12, with a deviation independent of the abscissa x and 0. A second case is illustrated by FIG. 14, with a non-constant deviation linear by pieces.

The second condition at the limits corresponds to the section through the plane x=0, that is to say through the vertical plane passing through the optical axis. The curve corresponding to this section is constructed according to the method disclosed previously so that all the emerging rays are descending or at the most horizontal. Under these conditions, it suffices to know a single adjoining point in order to construct a new point of the curve. This is because the left/right symmetry of the beam sought and of the emitter means that the normals to the surfaces along the sections passing through x=0 are contained in this same plane. This section through x =0 can be constructed point to point by means of the data of an initial point, advantageously formed by the intersection of the surface with the y axis. This point also constitutes the initial condition for the section through the plane z=0 and is determined by the thickness at the centre of the lens.

FIGS. 12 and 14 depict schematically the sections through a vertical plane passing through the optical axis of the two lenses of a module according to the invention, for which the exit surface As3 and As4 is a toric surface with a radius of revolution R=300 mm and a radius of curvature of the section r=50 mm.

In FIG. 12, the module is focused. The entry face Ae3 is symmetrical with respect to the optical axis and has a convex top 20 turned towards the source with a relatively great curvature that decreases on moving away from the optical axis.

FIG. 13 illustrates the network of isolux curves obtained with a module according to FIG. 12. The light beam has a horizontal cutoff line in the plane of the optical axis and is substantially symmetrical with respect to the vertical plane passing through this optical axis. The beam has a maximum illumination in its central zone corresponding to the focusing.

FIG. 14 is schematic vertical section similar to that of FIG. 12, of a module with a light source Dd, which corresponds to a vertical plate, orthogonal to the optical axis, with several light emitting chips aligned along the x axis.

FIG. 12 and 14 use the same light source, whilst FIGS. 13 and 15 are different since they choose different limit conditions in z=0.

The exit face As4 of the lens Ld is toric, identical to the exit face As3 in FIG. 12. On the other hand, the entry face Ae4 is less curved in the direction of the light source and the thickness of the lens along the optical axis is less.

FIG. 15 illustrates the network of isolux curves obtained with the module in FIG. 14. The cutoff line is always horizontal at the optical axis. The isolux curves are substantially symmetrical with respect to the vertical plane passing through the optical axis. The light is more spread than in the case of the curves in FIG. 13.

II.b—The Case Of Diodes With Protective Domes

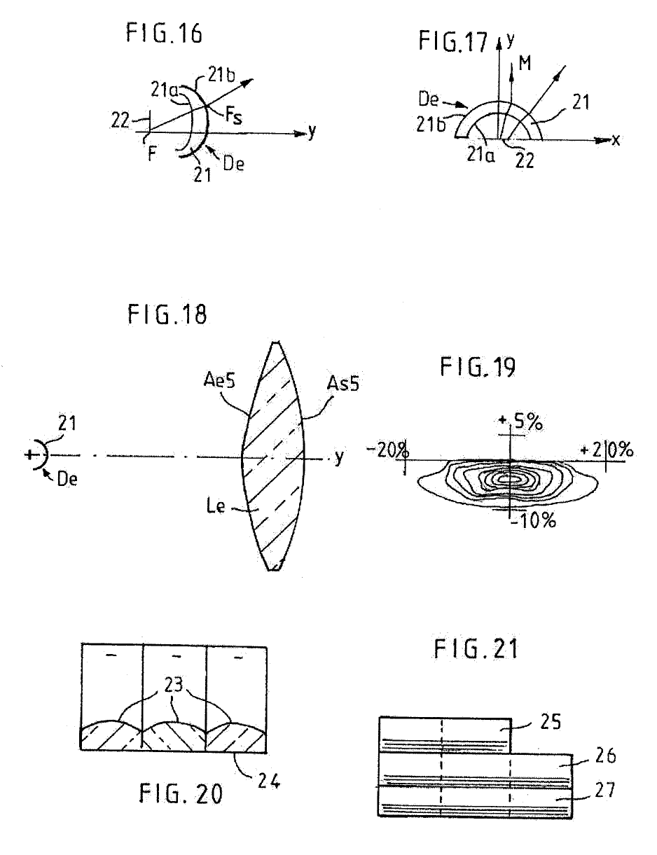

Referring to FIGS. 16 and 17, a light source De consisting of an LED comprising a transparent protective dome 21 situated below the emitter 22, itself placed in the air, can be seen. The internal face 21 a and the external face 21b of the dome 21, or protective bell, constitute two spherical dioptres between the air and the transparent material of the dome 21. These excessive deviations of the rays due to these two spherical dioptres are to be taken into account because on the one hand of the small value of the diameters of the spherical diameters, which are of the same order and magnitude as the large dimension of the emitter, and on the other hand the relatively great thickness of the dome 21, for example around 0.5 mm, which is the same order of magnitude as the small dimension of the source 22.

The method is as follows: for M given, the Fs closest to M are sought in projection on Ox (the furthest away for z negative, or the symmetrical point of the point cited for z positive, in the context of a simplified design) such that there exits a point F on the bottom edge of the emitter emitting a ray reaching M and passing though Fs: the corresponding emerging ray in Fs is the limit ray for M.

It should be noted that the spheres 21a, 21b are centered on the centre of the emitter 22 and not on its bottom edge, where the foci F must be taken. The result is that the height of the light source 22 is to be taken into account in the construction of the surface Ae5.

FIG. 18 is a schematic vertical section of a module with diode protected by a dome 21 constructed as disclosed above. The exit surface As5 of the lens Le is formed by a freely chosen toric surface, for example having a radius of revolution R=300 mm and a radius of curvature r=50 mm. The entry surface Ae5 has a convexity turned towards the light source De and is symmetrical with respect to the vertical plane passing through the optical axis.

FIG. 19 illustrates the network of isolux curves obtained with a module according to FIG. 18. The curves are situated below the horizontal plane passing through the optical axis. Each curve has a curvilinear substantially rectangular contour, the large sides of which are substantially horizontal, with a slight concavity turned downwards.

FIG. 20 illustrates schematically in horizontal section a headlight formed by the assembly of three modules, the exit surfaces of which are formed by cylindrical surfaces of revolution with the same radius of curvature. The entry surfaces, situated inside the headlight, form successive corrugations 23 whilst the exit surface is smooth and continuous, formed by a cylindrical surface, a generatrix 24 of which appears in FIG. 20.

FIG. 21 is a schematic front view of a headlight with several superimposed rows of assembled modules. The top row 25 corresponds to two modules providing a cutoff at 15°. The row in the middle 26 corresponds to three modules, two of which give a cutoff at 15° and the third illuminates towards the left. The bottom row 26 corresponds to three modules illuminating towards the right. Each switched-off row has the same external appearance of a single cylindrical bar or continuous toric segment.

II.c—The Case Of Diodes With Protective Domes: Variant Design

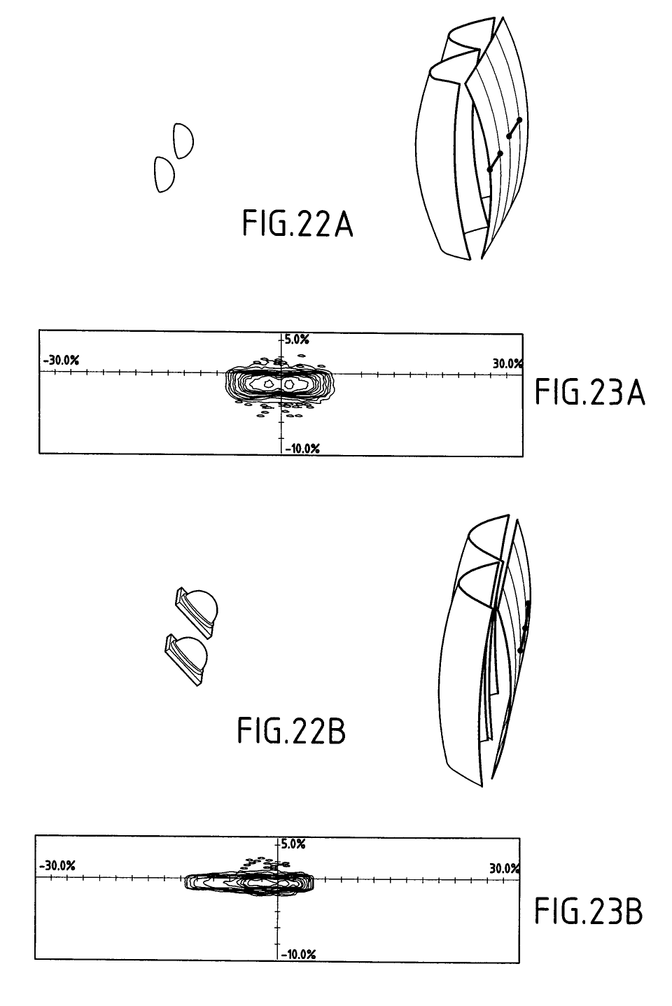

A variant design has also been provided in the case of modules functioning in particular but not exclusively with diodes with protective domes as depicted in FIGS. 22A and 22B. Let us take the case of a module as depicted in FIG. 22A, with a diode with a protective dome as described above and disposed opposite the lens and perpendicular to the optical axis.

The method of constructing the entry face of the lens is a little different from that described above: a point M₁ on the entry surface of the lens and the normal \vec{n}₁ to this surface at M₁ are considered to be known. There is also considered to be known an adjacent point M₀ and a new point M on the surface (for example,

$$M = [ \begin{matrix}{x}_{{M}_{0}} + δ x \\ y \\ {z}_{{M}_{0}}\end{matrix} ]$$

) is sought, where delta x and delta z are the steps of a meshing in rear view of the surface, in Cartesian coordinates.

By writing that \vec{M₁M}·\vec{n}₁=0, y is easily determined, and hence M:

$$y = - \frac{{n}_{{1}_{z}}}{{n}_{{1}_{y}}} δ z + {y}_{{M}_{1}} .$$

In order to be able to calculate the entire surface from point to point, it suffices to determine the normal \vec{n}₁ at M.

For this purpose, it is first of all written that \vec{M₀M}·\vec{n}=0.

As ∥\vec{n}∥=1 [symbol] nₓ²+n_{y}²+n_{z}²=1, with n_{y}≧0, it is deduced from this that

$${n}_{x} = - \frac{y - {y}_{0}}{δ x} {n}_{y}$$

$$and$$

$${n}_{y} = \sqrt{\frac{1 - {n}_{z}^{2}}{1 + {( \frac{y - {y}_{0}}{δ x} )}^{2}}} .$$

Let \vec{ν}ₒ, be the directing vector of the limit ray reaching the surface at M (that is to say the ray issuing from the source reaching M that must be diverted by the lens so as to emerge from it parallel to the plane (O,\vec{x},\vec{y}), so that all the other rays issuing from the source reaching the lens at M are diverted downwards), the direction \vec{r} of the corresponding ray is easily calculated, refracted at M by the surface sought, as a function of \vec{n}, that is to say of n_{z} and \vec{ν}ₒ. It is then easy to calculate the point of emergence P of this radius out of the lens as a function of n_{z} and \vec{ν}ₒ: λ is sought such that P+λ·\vec{r} belong to the torus of the exit surface. The normal at P being known (torus), the direction \vec{e} of the emergent ray is finally calculated, refracted at P, as a function of n_{z}.

It is then written that e_{z}=0, which is (\vec{ν}ₒ being known) an analytical equation with a single unknown (n_{z}) which can be resolved numerically in a reliable manner.

Determination of \vec{ν}ₒ:

$${{v}^{->}}_{o} = \frac{\vec{{F}_{s} M}}{{F}_{s} M} ,$$

where Fₛ is the point of emergence of the limit ray out of the spherical protective dome.

Let us assume Fₛ to be known: a ray (Fₛ,−\vec{ν}ₒ) is propagated through the dome (with a known refractive index and assumed to be spherical, centered on the origin of the reference frame) applying Descartes' laws of refraction (the normal to the dome at

$${F}_{s} is \frac{\vec{{OF}_{s}}}{{r}_{2}} ) .$$

Let \vec{r}′ be the direction of the refracted ray found, μ is sought such that Fₛ^{′}=Fₛ+μ·\vec{r}′ belongs to the internal surface of the dome (sphere of radius r₁). It is a case of a second degree polynomial equation, with an obviously analytical solution. It is then possible to calculate the direction \vec{i} of the ray emerging at Fₛ^{′}(the normal to the dome at

$${F}_{s}^{′} being \frac{\vec{{OF}_{s}}}{{r}_{1}} ) .$$

Then the intersection F of the straight line (Fₛ^{′},\vec{i}) with the (inclined) plane of the emitter is calculated.

Fₛ is well chosen when F belongs to bottom edge of the emitter (1^{st}equation) and when (2^{nd} equation) |x−x_{F}_{ₛ} | is:
a. for the top part of the lens: minimum
b. for the bottom part of the lens: maximum (which amounts to taking for F the bottom corner of the emitter, on the opposite side laterally to M with respect to the plane (O, \vec{y}, \vec{z})).

In the case of the part of the lens with z>0, F moves along the edge of the emitter in order to be rapidly constant (a bottom corner of the emitter, on the same side as M with respect to the plane (O, \vec{y}, \vec{z})), when x is close to or greater than the half width of the emitter).

Fₛ belonging to a centered sphere of given radius, its determination amounts to seeking two unknowns, which is easily achieved numerically from the analytical expression of the above two conditions.

It should be noted that, in our new method, the determination of F is not coupled to that of M as was previously the case, which affords improved stability of the calculations.

FIG. 23A shows the isoluxes obtained with a diode and a lens thus constructed: the distribution of the beam is well centered and horizontal. This type of beam can advantageously supplement a beam of the dipped type.

The two modules according to FIG. 22B correspond to a variant of the modules according to FIG. 22A: each module uses a diode with a dome that is inclined at approximately 45° upwards with respect to the optical axis.

The method of construction of the lens is in principle identical to that described in the context of FIG. 22A.

FIG. 23B shows the isolux curves obtained: it can be seen, in comparison with those in FIG. 23A, that the beam is much less thick, 3% less. The beam is intense (more than 40 lux at 25 meters), and has a sharp horizontal cutoff, above the horizontal below the dazzle threshold: this type of beam perfectly fulfils the conditions required for a beam of the regulatory type.

II.d Method Of Construction For Variant IIβ

It will be noted that this method applies to all types of sources (with protective dome or with emitter immersed in a protective material and with a known exit face, in particular planar).

Let us choose an arbitrary point Fs on the surface of the source.

Let us consider a point f situated on the bottom edge of the emitter (assumed to be rectangular, with large sides perpendicular to the directing vector of the optical axis y of the system). By applying Descartes' refraction laws, the direction \vec{ν}ₒ(f,Fₛ) of the light ray issuing from f passing through Fs when it leaves the source is easily calculated.

If there exists F such that the component along x (horizontal axis perpendicular to the optical axis) of \vec{ν}(f,Fₛ) is zero and its component along z positive, then F is a focus and (Fₛ,\vec{ν}ₒ(F,Fₛ)) is a limit ray. In the contrary case, if Fc+ designates the bottom corner of the emitter with the largest coordinate along x and the components along x and z of \vec{ν}ₒ(F_{c+},Fₛ) are positive, Fc+is a focus and (Fₛ,\vec{ν}ₒ(F_{c+,F}ₛ)) is a limit radius. In the contrary case, if Fc− designates the bottom corner of the emitter with the smallest coordinate along x and the components along x and z of \vec{ν}ₒ(F_{c-},Fₛ) are respectively negative and positive, Fc− is a focus and (Fₛ,\vec{ν}ₒ(F_{c-,F}ₛ)) is a limit ray. Otherwise, if the coordinate of Fs along x is greater than that of the centre of the emitter, Fc− is a focus and (Fₛ,\vec{ν}ₒ(F_{c-},Fₛ)) is a limit ray. Otherwise Fc+ is a focus and (Fₛ,\vec{ν}ₒ(F_{c+},Fₛ)) is a limit ray.

The rules set out in the previous paragraph completely describe the functions linking the focus and the limit ray corresponding to the point of emergence Fs of this ray out of the source.

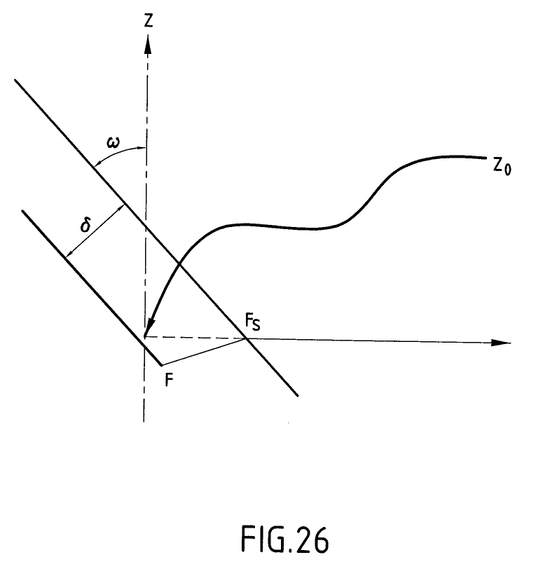

In the case of an emitter immersed in a material (planar exit surface source, inclined by an angle ω with respect to the vertical, with an emitter parallel to the exit face, situated at a distance δ below it, cf FIG. 26), if we put

$$i = arcsin ( \frac{sin ω}{{n}_{s}} ) ,$$

and if z₀ designates a measurement (the coordinate along z) situated

$$\frac{δ}{cos i} sin ( ω - i )$$

above the measurement of the large bottom side of the emitter, then:
if the coordinate along z of Fs is greater than z₀,
   if the coordinate x_{FS} along x of Fs is between the coordinates along x of Fc− and Fc+, then F is the point of the bottom edge of the emitter of coordinate x_{F}=x_{FS}.
   if x_{Fs} is greater than the coordinate x of Fc+, the focus is Fc+
   if x_{Fs} is lower than the coordinate of x of Fc−, the focus is Fc−
if the coordinate along z of Fs is less than z₀,
   if x_{Fs} is greater than the coordinate along x of the centre of the emitter, Fc− is the focus
   if x_{Fs} is less than the coordinate along x of the centre of the emitter, Fc+ is the focus.

In order to determine Ae6, the constancy of the optical path of the focus at the surface of the exit wave, along the limit rays, is written.

In practice the opposite direction to the propagation of the light is followed: let P′ be a point of the exit wave surface and let \vec{n} be the normal to this surface at P′. The intersection P of the toric exit surface As6 and the straight line (P′,\vec{n}), which is the support of a limit ray (forth degree polynomial equation) is determined analytically. The normal to the torus at P is then calculated and there is derived therefrom, knowing the refractive index of its material (etc), the direction of \vec{r} of the refracted ray inside the lens (Descartes' laws). μ and Fs are then sought such that P′P+n₁,μ+MFₛ+Cₛ=K (eqO) where M=P+μ·\vec{r}, where Cₛ is the optical path traveled in the source of Fs to the corresponding focus and where K is a constant that determines the thickness of the lens and such that the straight line (Fs, M) carries the limit ray passing through Fs. In the more general case, a system with three equations is obtained (the optical equation expressed above and the belonging of M to the straight line carrying the limit ray at Fs) with three unknowns (μ and two parameters for Fs, which is situated at the surface—known—of the source).

In the case of an emitter immersed in a material (planar exit surface source, with a rectangular emitter parallel to this), if z_{M}, the coordinate of M along z, is greater than z_{O}, if x_{M}, the coordinate of M along x, is between the coordinates along x of Fc− and Fc+, then x_{F}=x_{Fs},=x_{M}, otherwise F is situated at the bottom corner of the emitter situated on the same side as M (along x) with respect to the centre of the emitter, otherwise (z_{M}<z_{O}), F is situated at the bottom corner of the emitter situated on the opposite side to M (along x) with respect to the centre of the emitter.

In the above particular case, a law directly linking F to M (that is to say to the unknown μ) has just been established. Because of the first Descartes law (co-planarity of the rays and of the normal to the dioptre passed through), it is known that (\vec{FₛF}Λ\vec{FsM})·\vec{ν}=0 (second degree polynomial equation linking the coordinates of Fs to those of F and M and therefore to μ), where \vec{ν} is the normal to the exit face of the diode. In addition, Fs belongs to the exit plane of the diode, which constitutes a linear equation between the cordinates of Fs. Finally nₛ²(1−(\vec{FF}ₛ·\vec{ν})₂)=(1(\vec{FₛM}·\vec{ν})²) where ∥\vec{ν}∥=1 (the consequence of the second Descartes law of refraction), which constitutes, substituting therein the expression of one of the coordinates of Fs (for example along z) as a function of the others (expressions derived from the above two equations) a fourth degree polynomial equation, of analytical solution, giving z_{Fs} (from which the other coordinates are derived) as a function of μ. In the particular case considered, Cₛ=nₛ·FFₛ and it is therefore possible to express the optical equation eqO in the form of an equation with a single unknown: μ. Such an equation is easily resolved numerically by means of several methods known to persons skilled in the art. μ determines M and by making P′ vary the whole of Ae6 is determined.

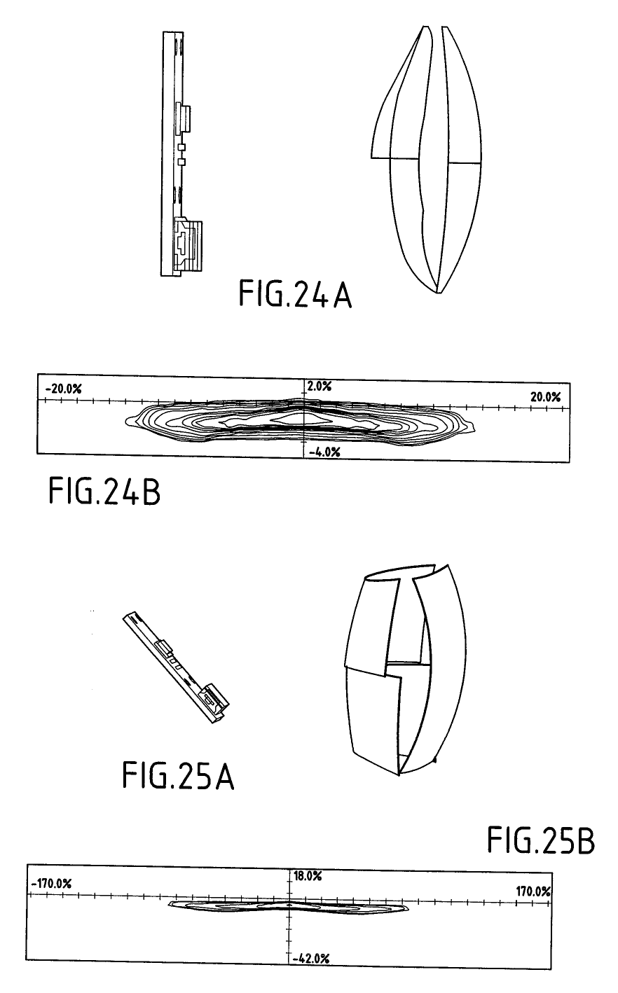

FIG. 24A shows a lens and its diode according to the variant IIβ, in a configuration intended to produce a fog beam according to the representation of the isoluxes in FIG. 24B. FIG. 25A shows a lens and its diode according to the variant IIβ, in a configuration intended to produce a complementary motorway beam, as depicted in the isoluxes in FIG. 25B. FIG. 26 depicts points and angles used in the description of the above construction method, in particular zo and the delta and omega angles.

In conclusion, the invention allows control of the horizontal distribution of the light and the obtaining of a cutoff, possibly complex, with an exit surface for each module possibly permitting the assembly of several modules creating a single global lens with a smooth external face.

It makes it possible to obtain optical modules, by various lens entry face construction methods, various types of diodes, and various types of positioning of these diodes, to best adjust the parameters of the light beam, in particular its thickness, the positioning of its cutoff etc, the modules having a remarkable very original style and great compactness, in particular in terms of depth.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. A construction method for a headlight module giving a beam with cutoff, for a motor vehicle, comprising a lens and a light source disposed at the rear of said lens, from which it is separated by air, said light source being formed by at least one light emitting diode, wherein an exit surface of said lens is chosen so that it can be connected along a smooth continuous surface with said exit surfaces of similar adjacent modules, and in that an entry surface of said lens is determined so as to obtain the cutoff of the light beam without using an occulting shield.

2. A construction method for a headlight module giving a beam with cutoff, for a motor vehicle, comprising a lens and a light source disposed at the rear of said lens, from which it is separated by air, said light source being formed by at least one light emitting diode, wherein an exit surface of said lens is chosen and in that an entry surface of said lens is determined using a horizontal generatrix, so as to obtain a cutoff of said light beam emitted by said headlight module without using an occulting shield, and with a generally horizontal distribution of said light beam.

3. The method according to claim 1, wherein said exit surface of said lens is chosen as being substantially cylindrical or toric, the cross-section of said exit surface of said lens through a vertical plane parallel to the optical axis being convex towards a front.

4. The method according to claim 1, wherein the curvature or curvatures of said exit surface of said lens are chosen so as to be substantially equal to the curvature of curvatures of at least one wall surrounding said headlight module.

5. The method according to claim 1 for constructing a module comprising an ellipsoidal reflector and a bender, wherein said exit surface is chosen as being substantially that of a cylinder of revolution whose cross-section through a vertical plane passing through said optical axis is an arc of a circle convex towards the front, and said entry surface is constructed so as to be stigmatic between the second focus of the ellipsoidal reflector and infinity.

6. The method according to claim 1 for constructing a module with diode in direct view of said lens, characterized in that said exit surface is chosen so as to be toric, with a vertical axis of revolution, and said entry surface is constructed so as to create a horizontal cutoff.

7. A headlight module giving a beam with cutoff, for a motor vehicle, comprising a lens and a light source disposed at the rear of said lens, from which it is separated by air, said light source comprising at least one light emitting diode, wherein said exit surface of said lens is entirely convex towards the front and is such that it can be connected along a substantially smooth continuous surface with said exit surface of lenses of similar adjacent modules, and an entry surface of said lens is defined so that said headlight module gives a light beam with cutoff without the intervention of an occulting shield, in particular vertical.

8. A headlight module giving a beam with cutoff, for a motor vehicle, comprising a lens and a light source disposed at the rear of said lens, from which it is separated by air, said light source comprising at least one light emitting diode, wherein the exit surface of said lens is entirely convex towards the front and the entry surface of said lens is defined according to a horizontal generatrix, so that said headlight module gives a light beam with cutoff without the intervention of an occulting shield, in particular vertical, and with a horizontal distribution.

9. The headlight module according to claim 7, wherein said entry surface of said lens is calculated so that a family of light rays, referred to as limit rays, issuing from said light emitting diode of said light source, emerge from said lens so that they are all normal, at the points where they encounter it, to a given surface referred to as the exit wave surface.

10. The headlight module according to claim 9, wherein said exit wave surface is cylindrical, with vertical generatrices and with any cross-section.

11. The headlight module according to claim 7, wherein said light source comprises said light emitting diode in direct view of said lens.

12. The headlight module according to claim 11, wherein said light emitting diode is disposed on a generally oblique plane with respect to said optical axis of said module.

13. The headlight module according to claim 7, wherein said light source comprises said light emitting diode having a transparent protective dome situated above said light emitting diode.

14. The headlight module according to claim 9, wherein said light emitting diode is sufficiently inclined so that the angle to which the emitter of said light emitting diode is seen from a majority of points on said lens is smaller than it would be with said lens disposed on a plane perpendicular to said optical axis of said headlight module.

15. The headlight module according to claim 9, wherein said light emitting diode is sufficiently inclined so that the most inclined ray with respect to the axis of said light emitting diode reaching said lens is smaller than the limit angle of the distribution of said light beam emitted by said light emitting diode.

16. The headlight module according to claim 9, wherein said light emitting diode is inclined with respect to said optical axis of said headlight module.

17. The headlight module according to claim 9, wherein it is able to emit a beam or a portion of a beam of the motorway type, having in particular a beam thickness of less than 5%, in particular less than 3%, high intensity, in particular at least 40 lux at 25 meters, and a cutoff above the horizontal.

18. The headlight module according to claim 7, wherein said light source comprises said light emitting diode in direct view of said lens and in that, in the mounting position, said light emitting diode and said lens are inclined laterally in a vertical plane, in particular to obtain a beam or a portion of light beam with oblique cutoff.

19. The headlight module according to claim 1, wherein said exit surface of said lens is cylindrical or toric, the cross-section of said exit surface of said lens through a vertical plane parallel to said optical axis being convex towards the front.

20. The headlight module according to claim 7, comprising an ellipsoidal reflector and a bender, wherein said exit surface is chosen as being that of a cylinder of revolution whose cross-section through a vertical plane passing through said optical axis is an arc of a circle convex towards the front, and said entry surface is constructed so as to be stigmatic between the second focus of the ellipsoidal reflector and infinity.

21. The headlight module according to claim 20, wherein the shape of the edge of said bender is designed so that said light beam has a V-shaped cutoff.

22. The headlight module according to claim 17, wherein said edge of said bender has a deformation in a protrusion in order to partly compensate for the aberrations of said lens.

23. The headlight module according to claim 20, wherein said edge of said bender has on each side of the vertical plane passing through said optical axis two protrusions connected by a part in a bowl in order to constitute an additional module for a motorway dipped beam, reinforcing the light in said optical axis below the horizontal.

24. The headlight module according to claim 20, wherein said entry surface is such that the optical path is constant from the external focus of the reflector as far as a plane tangent to the exit face at its point of intersection with said optical axis of said headlight module.

25. The headlight module according to claim 20, wherein the focus of said lens is offset transversely with respect to said optical axis and said headlight module illuminates in a natural direction with respect to said optical axis, said entry surface of said lens being such that said optical path is constant between the focus of said lens and a vertical plane whose trace on the horizontal plane of said optical axis is inclined with respect to said optical axis.

26. The headlight module according to claim 7, wherein said light source is in direct view of said lens, said exit surface of said lens is toric with a vertical axis of revolution, and said entry surface is defined so as to give a beam with a horizontal cutoff.

27. The headlight module according to claim 7, wherein said light source consists of a rectangular lambertian emitter placed in a vertical plane, orthogonal to said optical axis.

28. The headlight module according to claim 7, wherein said light source consists of said light emitting diode comprising a transparent protective dome situated above said light emitting diode, itself placed in the air.

29. The headlight module according to claim 7, wherein said headlight module comprises an assembly of a plurality of modules that cooperates to provide said substantially smooth surface.

30. The headlight module according to claim 8, wherein said headlight module comprises an assembly of a plurality of modules that cooperates to provide said substantially smooth surface.

31. An assembly of a plurality of headlight modules, said assembly giving a beam with cutoff, for a motor vehicle, comprising a lens and a light source disposed at the rear of said lens, from which it is separated by air, said light source comprising at least one light emitting diode, wherein said exit surface of said lens is substantially convex and comprises a substantially smooth continuous surface, and an entry surface of said lens is defined so that said assembly gives a light beam with cutoff, wherein said assembly of said plurality of headlight modules cooperate to provide said substantially smooth surface.
